(19) United States
(12) Patent Application Publication
(10) Pub. No.: US 2026/0017716 A1
(43) Pub. Date: Jan. 15, 2026

(54) METHODS FOR ENDOGENOUS DECENTRALIZED MONETARY SYSTEMS

(71) Applicant: MShift, Inc., Palo Alto, CA (US)

(72) Inventors: Xiaomeng ZHOU, Redwood City, CA (US); Scott MOELLER, Del Mar, CA (US); David TCHEAU, Cerritos, CA (US); Andrew YEE, San Francisco, CA (US)

(21) Appl. No.: 19/336,873

(22) Filed: Sep. 23, 2025

Related U.S. Application Data
(60) Provisional application No. 63/703,830, filed on Oct. 4, 2024.

(51) Int. Cl. G06Q 40/04; G06Q 20/38

(52) U.S. Cl. CPC G06Q 40/042; G06Q 20/381; G06Q 40/048

(57) ABSTRACT

A method is provided for an endogenous decentralized monetary system. The method comprises a governance token with limited issuance, a currency token with unlimited issuance, a target exchange rate between the currency token and a fiat currency, a standard interest rate credited to holders of the currency token, indicators of inflation or deflation of the currency token, compensation for merchants' exchange loss, mechanism for crisis detection and self-stabilization of the currency token. New currency tokens are originated from rewards to consumers, merchants, and payment gateways, whenever consumers transactions/consumption are performed. The money creation is endogenous to the consumption of widely distributed consumers and is separated from borrowing and lending activities. Smart contracts automatically adjust consumer reward percentages, merchant reward percentages, and the interest rate according to a predetermined policy cycle until inflation or deflation is stabilized within a 2% exchange rate range from the target exchange rate.

### CROSS-REFERENCE

This application claims the benefit of U.S. Provisional Patent Application No. 63/703,830, filed on Oct. 4, 2024, which is entirely incorporated herein by reference.

### BACKGROUND

Currently, from the standpoint of general consumers and retail merchants, all existing monetary systems of central banks, such as, the U.S. Federal Reserve System (the Fed), Bank of Japan (BOJ), Bank of England (BOE), European Central Bank (ECB), Bank of Canada, etc., are both centralized and exogenous, to the extent that the money supply (money creation and destruction, including credit creation and destruction by depository institutions) is determined by centralized authorities, independent of consumers' purchase of consumption goods and services at retail merchants. There is a fundamental disconnection between money supply and consumers' consumption at retail merchants.

Currently, from the standpoint of general consumers and retail merchants, all the existing decentralized finance (DeFi) platforms using blockchain and cryptocurrency are exogenous, to the extent that the money supply is determined by distributed participants and has nothing to do with consumers' purchase of consumption goods and services at retail merchants. The disconnection between money supply and consumers' consumption at retail merchants remains.

However, consumers' consumption (expenditures) is the ultimate destination for all production processes of the entire economy. All production processes are only intermediate way stations on the road to the eventual attainment of consumption goods and services. Therefore, the disconnection between money supply and consumers' consumption inevitably causes either money oversupply (inflation) or undersupply (deflation) measured by the percentage change of prices of a set of consumption goods and services in a given time period. Either inflation or deflation has and will lead to not only financial crises, but also to instabilities of the entire economy.

### SUMMARY

The present disclosure provides methods for endogenous decentralized monetary systems using blockchain and cryptocurrency. The method and systems herein may utilize two digital tokens. A first token is a governance token, the holders of which have the right to participate in governmental affairs of the monetary system, such as rulemaking and decision-making process for the monetary system. A second token is a currency token, which can be used by holders to purchase consumption goods and services at participating retail merchants. The governance token has a finite number, while the currency token may not have a finite number (i.e., having a variable number).

One of aspects of the present disclosure is directed to a method for the governance token, which is distributed, free of charge, to these retail merchants, individuals and entities who may participate in governmental affairs of the monetary system and may sell the governance token on crypto markets forming a secondary market for the governance token.

One of aspects of the present disclosure is directed to a method for new money supply of the currency token. Most of new money supply of the currency token, except for two scenarios to be disclosed in the disclosure herein, are triggered by consumers' purchases of consumption goods and services at various retail merchants of broad verticals. This process of new money supply of the currency token can ensure that a monetary system is endogenous to consumers' purchases of consumption goods and services at retail merchants. As used herein, an endogenous system refers to a system in which new money creation of the currency token (an addition to existing money stock in an economy) originates from and is triggered by consumer's purchases of consumption goods and services. In addition, because the triggers of new money supply of the currency token are consumers' purchases of consumption goods and services, the decision-making process of new money supply is widely decentralized to each individual of mass consumers. To this extent, the money supply of the currency token is in proportion to consumers' consumption. The new money supply of the currency token is created for and delivered as incentives to consumers, merchants and payment gateways. The incentives herein can be interchangeably described as rewards. The incentives can be adjusted for the purposes of controlling new money supply, thereafter, inflation (oversupply) and deflation (undersupply). Consumption goods and services mean these goods and services which are immediately and directly serviceable in the satisfaction of the actor's wants. In other words, those goods and services which may be transformable into directly serviceable goods and services only at some point in the future, are not consumption goods and services. There is no new money supply of currency token generated by these purchases of goods and services which are not consumption goods and services.

New money supply of currency token, as incentives, is fundamentally different from loyalty points issued by merchants or credit card companies. The life cycle of these loyalty points ends at the time of use (redemption). In contrast, once new money supply of the currency token is issued, its circulation from one holder to another will continue after each use. Furthermore, by nature, loyalty points are designed to be used only at the issuing merchants or at specific merchants designated by credit card companies, while the currency token is designed for ubiquitous use for all participants and scenarios, including but not limited to, ubiquitous use at all merchants and their supply chains. Therefore, as a result of ongoing consumers' purchases of consumption goods and services, the money stock of the currency token will permeate into the entire economy and will be accumulated in the possession of participants across board.

One of aspects of the present disclosure is directed to a method for interest paid to holders of the currency token without any borrowing and lending relationship between the monetary system and the holders of the currency token. The process of interest payment is created, simply because the interest rate can be adjusted to encourage or discourage consumption and savings, for the purposes of controlling new money supply of the currency token, therefore, inflation (oversupply) and deflation (undersupply). The interest payment delivered by the monetary system to the currency token holders is one of the only two scenarios exogenous to consumers' purchases of consumption goods and services.

One of aspects of the present disclosure is directed to a method for combining both the adjustment of the interest rate for holding the currency token and the adjustments of incentives for purchasing consumption goods and services. These processes of combining the adjustments of both interest rate and purchase incentives can be defined and modified by the rulemaking processes of the governance token. The governance token is mainly distributed, free of charge, to retail merchants and early contributors who may sell their holdings of their governance tokens through open crypto markets. This process of distributing governance tokens is to ensure that the processes of rulemaking by the governance token involve both retail merchants and randomly decentralized participants. The involvement of random participants is one of the decentralized elements, while the merchants' involvement of rulemaking is not only one of the endogenous elements impacting merchants' motivations, efforts and incentives of accepting the currency token, but also is one of the decentralized elements.

One of aspects of the present disclosure is directed to various methods for combining objective measurements of inflation (oversupply of the currency token) and deflation (undersupply of the currency token), with various adjustments of both interest rate and purchase incentives. The processes of combining these measurements, the incentives and the interest rate are to achieve zero inflation and zero deflation, while preventing and overcoming crises of the currency token, including its value's freefall against the US dollar (USD). A freefall crisis of the currency token means that the currency token's value against USD on crypto markets declines 5% or more over a 24-hour period.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an example of a decentralization process of the governance token with a blockchain network.

FIG. 2 illustrates an example of payment flow of the currency token with a blockchain network.

### DETAILED DESCRIPTION

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby. In the description disclosed herein, the term “and” includes the term “or,” and the term “or” includes the term “and.” The singular includes the plural, and the plural includes the singular.

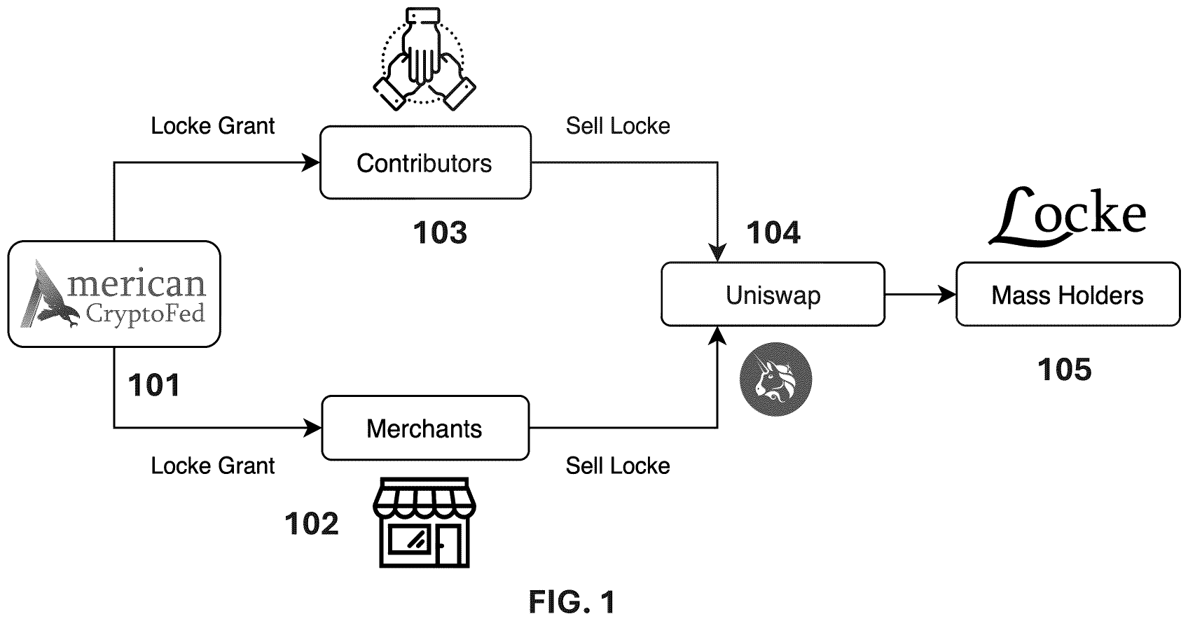

FIG. 1 illustrates an example of a decentralization process of the governance token of a blockchain-based monetary system. The monetary system 101 can comprise and/or be in communication with a blockchain network. The monetary system 101 herein can be interchangeably described as CryptoFed. The governance token herein can be interchangeably described as Locke. In an embodiment disclosed herein, the monetary system can comprise or be in communication with multiple blockchains.

In the embodiment disclosed herein, Locke has a finite number, such as 10 trillion. Locke can be burnt (destroyed). The Locke burnt is not counted towards the finite number. Locke can be issued on multiple blockchains. The Locke on each blockchain is counted towards the finite number.

CryptoFed 101 distributes Locke, free of charge, to retail merchants 102 which sells consumption goods and services. In order for CryptoFed to be endogenous from the standpoint of consumers' purchases of consumption goods and services at retail merchants, a decent amount of Locke is distributed to retail merchants to enable merchants' participation in governmental affairs of the monetary system. In addition, CryptoFed 101 distributes Locke, free of charge, to contributors 103 who are various individuals or entities, including but not limited to, employees of retail merchants, crypto savvy individuals and entities of crypto industry. These contributors make contributions in one way or another at their own efforts and at their own discretion. In order for CryptoFed to be decentralized, the distribution to retail merchants and contributors, free of charge, is an ongoing process.

In the embodiment disclosed herein, CryptoFed distributes the right to retail merchants and contributors to claim Locke. On each day, a maximum number of Locke, such as 50 million units, can be claimed. The remaining claim availability for the day is designed for retail merchants and contributors to understand their claimable tokens at any given time.

In the embodiment disclosed herein, retail merchants and contributors sell the Locke in their possession on decentralized crypto markets, such as Uniswap 104. In some embodiments, crypto markets can be centralized. Overtime, through the sales of Locke by contributors and retail merchants, mass holders of Locke 105 can be reached for further decentralization of CryptoFed. While CryptoFed's decentralization is an ongoing process, Locke holders at any given time are empowered to initiate and participate in the processes of rulemaking and decision-making for CryptoFed at their own discretion through voting and proposing activities.

In the embodiment disclosed herein, the currency token will not be issued until Locke is traded on crypto markets 104 for a certain time period, such as one year. In some embodiments, the currency token will not be issued until Locke per unit reaches certain value, such as, $0.10 USD per unit on crypto markets. The computation of the Locke value can be an average over a given time period, such as a three-month smooth average.

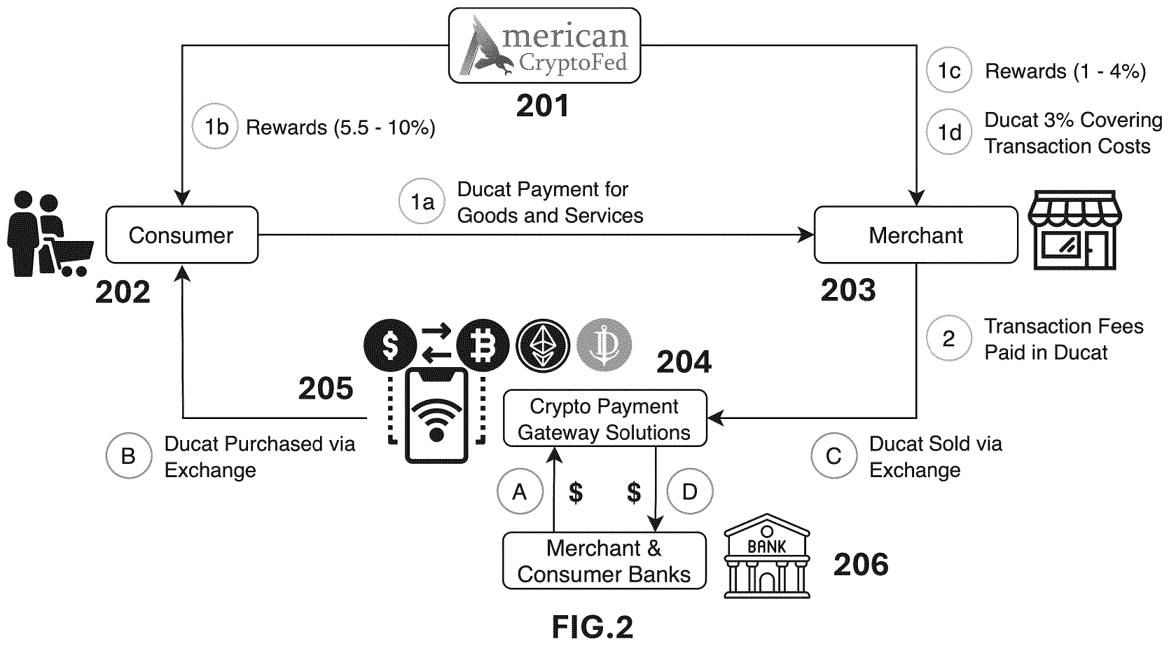

FIG. 2 illustrates an example of payment flow of currency token with a blockchain network. The incentives of (1b), (1c) and (1d) are new money supply of the currency tokens. The currency token herein can be interchangeably described as Ducat. Ducat can be issued on multiple blockchains. New Ducat money supply must be integrated with the payment process of consumers' purchases of consumption goods and services at retail merchants, in order that new Ducat money supply is endogenous, from the standpoint of consumers' purchases of consumption goods and services at retail merchants. However, CryptoFed 201 is not responsible for moving existing Ducat from a consumer 202 to a retail merchant 203. Moving Ducat from one holder to another is a payment process (1a). CryptoFed focuses on new Ducat money supply through incentives based on certain percentage of purchase (1a). These incentives are (1b), (1c) and (1d) and can be interchangeably be described as rewards. Reward (1b), (1c) and (1d) can interchangeably be described as reward rate (1b), (1c) and (1d). Because the new Ducat money supply through (1b), (1c) and (1d) is triggered by payment process (1a) and are determined by certain percentage of (1a), Ducat money supply is endogenous to consumers' consumption. To the extent that it is distributed to mass consumers who individually transact (1a) to generate (1b), (1c) and (1d), Ducat money supply is decentralized. In the embodiment disclosed herein, the payment process (1a) is the business of payment vendors employed by retail merchants. These vendors can be interchangeably described as crypto payment gateway 204 which can be in communication with crypto exchanges 205 and USD depository institutions, such as banks used by merchants and consumers 206. Crypto payment gateway 204 may also be in communication with point of sales (POS) of retail merchants and crypto wallets of consumers and merchants.

CryptoFed provides incentives (1d) to merchants to employ their own payment gateways, in order to achieve zero transaction fees incurred by merchants. On behalf of merchants and in accordance with merchants' instructions, these payment gateways will handle point of sales, crypto wallets, regulatory compliance, consumers' return of goods and services, etc. Through their payment gateways, retail merchants will onboard their customers, while CryptoFed will deliver sign-up bonuses automatically in real time after receiving the signal of onboarding completion from retail merchants. In the embodiment disclosed herein, when a consumer 202 visits retail merchant 203 to purchase consumption goods and services, the consumer may be presented a sign-up bonus in Ducat worth certain amount of USD, such as, $500-$1000 USD. The specific amount of sign-up bonus for a given time period may be decided in advance by votes of Locke holders from time to time and shall be attractive enough to incentivize consumers to use the Ducat sign-up bonus for immediate purchases at merchants.

Once a consumer 202 receives a sign-up bonus from CryptoFed 201 at a retail merchant 203, the consumer will use the sign-up bonus to immediately purchase goods and services at the merchant. The process of delivering sign-up bonus by CryptoFed to a consumer is a process of endogenous Ducat money supply, because the process is triggered by consumers' consumption action at the merchants and adds additional Ducat to the total stock of existing Ducat. Once the sign-up bonus is owned by a consumer and is used to purchase consumption goods and services, the process of new Ducat money supply ends and a payment process of moving Ducat from one holder to another begins.

The payment process for the purchase using the Ducat sign-up bonus is one example of (1a), which simultaneously triggers rewards (1b), (1c) and (1d). Reward (1b) is to provide incentive to the consumer; reward (1c) to merchant; and (1d) to crypto payment gateway through the merchant. The rewards (1b), (1c) and (1d) are delivered by CryptoFed and are new Ducat money supply. These rewards add additional Ducat to the total stock of existing Ducat. By nature, all rewards (1b), (1c) and (1d) are dependent on and endogenous to consumers' consumption (1a).

Rewards (1b) and (1c) are adjusted more frequently than Ducat sign-up bonus and reward (1d). In the embodiment disclosed herein, rewards (1b) and (1c) are adjusted every three months; Ducat sign-up bonus is adjusted every six months; reward (1d) are adjusted every three years. Reward (1b) may always be equal to or greater than 5.5%. Reward (1c) may always be equal to or greater than 1%. Reward (1d) may always be equal to or greater than 3%.

The purposes to adjust Ducat sign-up bonus, rewards (b), (1c) and (1d) in FIG. 2 are to avoid either Ducat money oversupply (inflation) or undersupply (deflation) against Ducat money demand in the economy. Rewards (1b) and (1c) will need to provide sufficient, direct and immediate benefits to drive Ducat adoption by merchants and mass consumers. Mass consumers through their actual consumption will trigger additional new Ducat money supply in the form of rewards, which in turn encourages additional consumers' consumption. The consumers' consumption is the ultimate destination for all production processes, e.g. supply chains, of the entire economy. Thus, rewards (1b) and (1c), through maximizing the consumption by mass consumers, will generate effective demand for maximum production by supply chains, and therefore, maximum economic growth and maximum employment. However, for a given time period, such as three months, the instantaneous speed of money supply increase may exceed the instantaneous speed of money demand. If Ducat oversupply exists, a reduction of rewards (1b) and (1c) should begin.

Rewards (1b) and (1c) in FIG. 2 may lead to oversupply or undersupply of Ducat at a given time period, leading to inflation or deflation measured by the percentage change of prices of a set of consumption goods and services in Ducat. In addition to the adjustment of (1b) and (1c), increasing or decreasing the interest paid to Ducat holders, including merchants and consumers, can encourage or discourage Ducat holders to hold Ducat at their own wallets rather than using it. Although CryptoFed does not conduct any borrowing and lending business, and although Ducat holders keep their Ducat at their own wallets (not in CryptoFed's custody), CryptoFed still pays interest to Ducat holders across the board, simply because interest rate is a necessary tool to encourage or discourage consumers' consumption, and therefore, the effective demand for production of supply chains. To this extent, CryptoFed's interest payment is fundamentally different from interest paid by a borrower to a lender or paid by a bank to a depositor. Ducat holders' custodians may receive the interest payment on behalf of Ducat holders.

In addition to influencing consumers' behavior of saving and consumption, CryptoFed interest payment to Ducat holders in Ducat can also influence the borrowing and lending markets of Ducat, which in turn influences all market participant's decisions to save, invest, or consume in Ducat. In the embodiment disclosed herein, the interest rate can go as high or low as needed, but it will never be negative and must be higher than the Fed's real federal funds rate which is defined as the Fed's effective federal funds rate minus the annual core PCE (Personal Consumption Expenditures Price Index) inflation rate (excluding food and energy) published by the U.S. Bureau of Economic Analysis (BEA). In the embodiment disclosed herein, CryptoFed should maintain a Standard Ducat Interest Rate which is 1% higher than the Fed's real federal funds rate. When the Standard Ducat Interest Rate is not the status quo, the priority is to lower or increase CryptoFed's interest rate towards the Standard Ducat Interest Rate. If no CryptoFed's participants are willing to keep Ducat balance longer than instantaneously, there will be no Ducat held and no use for a Ducat money stock. Ducat, in short, would either be useless or very nearly so. The Standard Ducat Interest Rate must be high enough to incentivize Ducat holders to keep their Ducat balance, while being low enough to encourage the free market activities of Ducat borrowing and lending markets which is a major driving force of economic growth.

In the embodiment disclosed herein, every quarter (3 months), in response to an ever-changing world and its uncertainties, when inflation occurs, the interest rate shall be increased, while rewards to consumers (1b) and to merchants (1c) in FIG. 2 shall be reduced. When deflation occurs, the interest rate shall be decreased, while the rewards (1b) and (1c) in FIG. 2 shall be increased. The combination of CryptoFed's interest rate and rewards (1b) and (1c) in FIG. 2 will be adjusted in accordance with predetermined set of rules executed automatically by CryptoFed's blockchain. The combined adjustments are designed to increase or decrease the direct and immediate incentives which will guide and induce the behaviors of merchants, consumers, Ducat holders and the borrowing and lending market of Ducat. In the embodiment disclosed herein, when, for a certain period, such as four consecutive quarters, Ducat inflation cannot be cured by the combination of reward rate 5.5% to consumers and 1% to merchants, and interest rate 5% to Ducat holders, then, the reward rate to consumers (5.5%) and to merchants (1%) will continuously be lowered 20% quarterly towards the direction of zero, until the inflation is cured. This scenario is rare, but cannot be completely ruled out. Once the inflation is cured, and if CryptoFed's interest rate is on the level of Standard Ducat Interest Rate, the reward rate to consumers will be adjusted towards 5.5%, and the rewards to merchants towards 1% respectively, but the rewards previously raised will be reversed if inflation returns. To the extent that the reward rate and interest rate are adjusted independently of recipients in accordance with predetermined set of rules determined by Locke holders and executed automatically by CryptoFed's blockchain, the Ducat reward payment and interest payment are not rights or entitlements of the recipients. The reward rate and interest rate are policy tools of the monetary system created for effective operations.

The combined adjustments of CryptoFed's interest rate and rewards (1b) and (1c) in FIG. 2, is a methodology to shift the fundamental economic conditions for these households (consumers) and businesses (merchants) who use Ducat for daily economic activities. The combination will be implemented quarterly to cure inflation and/or deflation which may occur. In the embodiment disclosed herein, a typical life cycle of combined adjustments for curing inflation and/or deflation may consist of the following steps which can be predetermined by Locke holders and executed automatically by smart contracts on the blockchains of the monetary system, following the first indicator described elsewhere herein for the quarterly adjustment of CryptoFed's interest rate and rewards. The first indicator will determine whether and when each step is triggered.
Step 1: A combination of 20% consumer reward reduction towards 5.5%, 15% merchant reward reduction towards 1% and 0.25% increase of interest rate from the Standard Ducat Interest Rate, can be implemented and repeated every quarter until the inflation is cured. The Standard Ducat Interest Rate is 1% higher than the Fed's real federal funds rate.
Step 2: Once the inflation is cured, the next quarterly adjustment is to reduce the interest rate 0.25% each quarter towards the Standard Ducat Interest Rate, while continuing the reduction of 20% on consumer reward rate and 15% on merchant reward rate to preempt inflation revival due to CryptoFed's interest rate reduction.
Step 3: When, and only when, CryptoFed's interest rate reaches the Standard Ducat Interest Rate, will the reductions of interest rate, consumer reward and merchant reward stop.
Step 4: If inflation restarts under the Standard Ducat Interest Rate, the reduction of 20% on consumer reward rate and 15% on merchant reward rate will be resumed until the rewards reach 5.5% to consumers and 1% to merchants.
Step 5: If inflation continues when consumer reward is 5.5% and merchant reward is 1%, the interest rate will be raised again by 0.25% each quarter until the inflation is cured or the interest rate reaches 5%, whichever is earlier.
Step 6: When, for four consecutive quarters, Ducat inflation cannot be cured by the combination of 5.5% reward rate to consumers and 1% to merchants, and 5% interest rate, then, the reward rate to consumers (5.5%) and to merchants (1%) will be lowered 20% quarterly towards the direction of zero, until the inflation is cured.
Step 7: Once the inflation is cured, the highest priority is to reduce interest rate 0.25% each quarter and move CryptoFed's interest rate towards the level of the Standard Ducat Interest Rate, but the interest rate reduced previously will be reversed, if inflation restarts.
Step 8: If the Standard Ducat Interest Rate is reached and maintained, the reward rate to consumers will be raised 20% each quarter towards 5.5% or higher and the reward to merchants 15% each quarter towards 1% or higher respectively, but the rewards previously raised will be reversed, if inflation returns.
Step 9: Under the condition that CryptoFed's interest rate is on the level of the Standard Ducat Interest Rate, the reward rate to consumers is 5.5% or higher, and the reward to merchants is 1% or higher respectively, if there is neither inflation nor deflation, the status quo will be maintained.
Step 10: If there is deflation, the increase of 20% of the consumer reward rate and 15% of the merchant reward rate respectively, will be repeated every quarter until the deflation is cured, while the Standard Ducat Interest Rate is maintained.
Step 11: The life cycle of Step 1 through Step 10 can be repeated as needed.

To implement the adjustment of CryptoFed's interest rate, to implement the adjustments of Ducat sign-up bonus, rewards (1b), (1c) and (1d), CryptoFed must have an objective and transparent, visible measurement to determine whether there is Ducat oversupply (inflation) or Ducat undersupply (deflation) in the entire economy. The measurement is the exchange rate between Ducat and USD-pegged stablecoin on crypto markets which is objective, transparent and publicly available. The exchange rate between USD-pegged stablecoin and Ducat can be interchangeably be described as the exchange rate between USD and Ducat. To the extent that Ducat is a currency token for daily use for consumers' purchases of consumption goods and services at merchants, and will be circulated from one holder to another, Ducat is similar to USD. To the extent that Ducat is not pegged to USD, Ducat is not a stablecoin. The exchange rate between USD and Ducat is always floating and is subject to market force. Because USD inflation rate as measured by a set of goods and services is published by the U.S. Bureau of Economic Analysis (BEA) on a monthly basis, and because CryptoFed aims to maintain zero inflation and zero deflation in Ducat measured by the same set of goods and services, the difference in inflation rate or deflation rate of the two currencies at any given time period, should be reflected, in theory, by the exchange rate between the two currencies, ceteris paribus. This theoretical exchange rate between Ducat and USD on any given day is the Target Exchange Rate.

The Target Exchange Rate can be obtained through calculation under the ceteris paribus condition, in accordance with the desired zero inflation/deflation rate of Ducat and the USD inflation rate published by the U.S. Bureau of Economic Analysis (BEA). In addition, because the desired Ducat's inflation/deflation rate is zero and the actual USD's inflation rate is not, the Ducat's Target Exchange Rate against USD, in theory, must appreciate on a daily basis accordingly.

In practice, the ceteris paribus condition used for obtaining the Target Exchange Rate can never be met in an ever-changing world. At any given time, on crypto markets, Ducat's value against USD can be higher or lower than the Target Exchange Rate. At any given time, if the Ducat market value against USD on crypto exchanges is lower than the Target Exchange Rate, Ducat will have oversupply, e.g. Ducat inflation. At any given time, if the Ducat market value against USD on crypto exchanges is higher than the Target Exchange Rate, Ducat will have undersupply, e.g. Ducat deflation. An upper bound 2% and lower bound 2% from the Target Exchange Rate can be considered normal deviation.

Merchants may have exchange rate gain or loss against the Target Exchange Rate at any given time. Ducat's value against USD may experience freefall during an unexpected economic shock. For the purposes of stabilizing retail prices in Ducat for consumers on daily basis, Ducat is paid to merchants to protect merchants from suffering any exchange loss caused by their conversion from Ducat to USD. This protection is necessary in order that merchants are not forced to increase their retail prices of goods and services in Ducat, simply because of the Ducat's depreciation against USD on crypto markets. This method of protection can be described as the Shield for Merchants' Exchange Loss.

In the embodiment disclosed herein, whenever merchants suffer loss caused by conversion from Ducat to USD, CryptoFed will automatically cover merchants' loss by issuing additional Ducat to merchants. Thus, in a short period, such as 24 hours, merchants are incentivized to keep their retail prices of goods and services in Ducat unchanged, in order not to drive their customers to their competitors, even if Ducat depreciates against USD. Competition among merchants themselves is one of the key factors driving merchants to keep their retail prices of goods and services in Ducat unchanged.

Whenever Ducat depreciates against USD, consumers through their Ducat wallet app or through other means, such as social media, may realize that they can use the same amount of USD to buy more Ducat through the processes of (A) and (B) in FIG. 2, and therefore, more goods and services from merchants at which they do shopping on a regular basis. Because consumers can buy the same goods and services at the merchants with the same Ducat, and because consumers can buy more Ducat with the same amount of USD-pegged stablecoins during Ducat's depreciation, consumers will buy more and more Ducat to enjoy the Ducat's depreciation as discount, and consequently bringing Ducat price back to the Target Exchange Rate.

From consumers' perspective, the Ducat depreciation is equivalent to discounts of merchants' goods and services. The larger the Ducat's depreciation, the larger the discount of goods and services consumers can enjoy, and therefore, the more Ducat consumers will purchase. In some embodiments, consumers use USD deposited at their banks 206 to buy USD stablecoins at crypto exchanges 205 via process (A) in FIG. 2 and subsequently convert these USD stablecoins to Ducat via process (B) in FIG. 2. In some embodiments, process (A) may not be needed, if consumers already have USD stablecoins in their possession. In other embodiments, process (A) can be a conversion from other crypto currencies to USD stablecoins via crypto exchanges 205. The Ducat's purchase by mass consumers enjoying Ducat's depreciation as discount, will drive Ducat's appreciation towards the Target Exchange Rate. Day by day, merchants are protected by the Shield for Merchants' Exchange Loss. Merchants will enjoy and get used to this protection on a daily basis which, in turn, will play the role of crisis prevention in Ducat, because a Ducat crisis will be nipped in the bud daily, even hourly. Through the Shield for Merchants' Exchange Loss, a mechanism of market force is established, which is widely distributed down to individual consumers and individual retail merchants. It is this distributed market force that will play an important role, even during unexpected economic shocks, to automatically maintain Ducat stability.

In the course of ordinary business, on a daily basis, merchants receive a lot of Ducat from consumers who purchase consumption goods and services at merchants. As a result, merchants usually, in the course of ordinary business, sell Ducat on crypto markets in exchange for USD-pegged stablecoin via process (C) in FIG. 2, because merchants need to exchange USD-pegged stablecoins for USD via process (D) in FIG. 2 to pay their suppliers in their supply chain, wages, rents, taxes, etc. Overtime, with the growth of Ducat in scale and ubiquity, merchants' need to sell Ducat may gradually reduce, because merchants may be able to pay suppliers, wages, rents, taxes, etc. in Ducat.

When merchants sell Ducat via process (C) at crypto exchanges 205 in FIG. 2, consumers purchase Ducat via process (B) at crypto exchanges 205 in FIG. 2. From time to time, consumers' demand for Ducat may exceed the Ducat sold by merchants. Ducat may sharply appreciate against USD, because of various reasons, such as new merchants' adoptions or campaigns on their own initiative. When, and only when, Ducat's appreciation against USD surpasses 2% of the Target Exchange Rate, will CryptoFed automatically sell Ducat through open crypto markets to deter the Ducat's appreciation so that consumers do not have to use significantly greater USD than the Target Exchange Rate to buy the same Ducat.

CryptoFed's sales of Ducat in exchange for USD on open crypto markets is one of the only two scenarios exogenous to consumers' consumptions. The other one is CryptoFed's interest payment. The proceeds in USD stablecoins from CryptoFed's sales of Ducat must be used to buy back Locke from open crypto markets. The Locke bought back will be burnt (destroyed). As a result, Locke on crypto markets will likely maintain and increase its price overtime. Then, Locke can be issued to buy back Ducat when, and only when, Ducat's depreciation against USD surpasses 2% of the Target Exchange Rate. The Ducat bought back will also be burnt (destroyed). This process of buying and selling Ducat to maintain the Target Exchange Rate is called Open Market Operation. While, by design, the combination of CryptoFed's interest rate and rewards (1b) and (1c) in FIG. 2 is only adjusted at intervals, such as every three months, Open Market Operation can be conducted anytime once the conditions are met. During each three-month interval, Ducat's price against USD on crypto markets may be higher (deflation signal, Ducat undersupply) or lower (inflation signal, Ducat oversupply) than the Target Exchange Rate. Once the deviation of Ducat price against USD on crypto markets is beyond the 2% range of Target Exchange Rate, Open Market Operation is triggered.

In the embodiment disclosed herein, whenever Ducat price on crypto markets is 2% higher than the Target Exchange Rate, CryptoFed's smart contract will automatically create and sell new Ducat in exchange for USD-pegged stablecoins on crypto markets to drive the Ducat's price down towards the Target Exchange Rate. The USD-pegged stablecoins received will solely be used to buy back Locke tokens from crypto markets for burning (destroying). CryptoFed will buy back Locke tokens whenever the Locke's price falls a certain percentage below its previous price over a certain time period, such as 3% over a 24-hour period, or 5% over a 1-hour period. Whenever the Locke's price falls sharply beyond a certain percentage below its previous price over a certain time period, such as 30% over a 24-hour period, CryptoFed is designed to use all available CryptoFed's USD-pegged stablecoins to buy back Locke tokens. This Open Market Operation is predetermined by Locke holders and is automatically executed by smart contracts, and will increase or maintain the price of Locke tokens on crypto markets.

Whenever Ducat price on crypto markets is 2% lower than the Target Exchange Rate, CryptoFed's smart contracts will automatically create and sell new Locke in exchange for Ducat tokens on crypto markets for burning (destroying) to bring the Ducat's price back to the Target Exchange Rate. This Open Market Operation will reduce the price of Locke tokens on crypto markets. In order for Locke to be an efficient vehicle for buying back Ducat, CryptoFed will not issue Ducat until Locke reaches certain price per unit, such as $0.10 USD per Locke.

The Ducat circulation can become greater and greater overtime. When more and more Locke is used to buy back Ducat, the price of Locke may potentially fall. During a Ducat freefall crisis, the predetermined emergency mode described elsewhere herein will terminate Ducat's buyback with Locke, partially because CryptoFed is not allowed to issue unlimited Locke to buy back Ducat, and partially because the Ducat's buyback will not be effective due to the commensurate price fall of Locke. Ducat freefall crisis means that Ducat's value against USD on crypto markets declines 5% or more over a 24-hour period. To cure the Ducat freefall, the most effective method will be the predetermined emergency mode which sets the combined adjustments of CryptoFed's interest rate and rewards (1b) and (1c) in FIG. 2, in conjunction with the Shield for Merchants' Exchange Loss. The emergency mode will directly and immediately increase the fundamental incentives for merchants and consumers to hold and own more Ducat.

The combined adjustments of CryptoFed's interest rate and rewards (1b) and (1c) in FIG. 2, in conjunction with the Shield for Merchants' Exchange Loss, are an ultimate and direct method to alter the behaviors of merchants and consumers, while Open Market Operation is a tool only effective for either the early stage of Ducat implementation or during non-crises time. For a large Ducat economy, the Shield for Merchants' Exchange Loss must be conducted daily, while CryptoFed's interest rate, rewards (1b) and (1c) in FIG. 2 can be adjusted on a quarterly basis, in conjunction with the predetermined emergency mode of immediate implementation.

However, in an ever-changing world, a crisis of Ducat freefall against USD may still occur. The longer the duration of the crisis, the less the merchants' confidence in keeping retail price in Ducat unchanged. Some merchants may even stop accepting Ducat. In the embodiment disclosed herein, prior to Ducat freefall, indicators are provided to forecast the possibility of Ducat freefall. The indicators immediately trigger the predetermined emergency mode to implement the combined adjustments of interest rate and rewards (1b) and (1c) in FIG. 2, to encourage all Ducat holders, including merchants and consumers, to hold and own more and more Ducat. During the implementation of the predetermined emergency mode, CryptoFed shall reduce immediately and substantially rewards to consumers (1b) and rewards to merchants (1c) in FIG. 2, while immediately and substantially increasing interest rate for interest payment to Ducat holders. In the embodiment disclosed herein, Open Market Operation is conducted whenever the deviation of Ducat price against USD on crypto markets is beyond the 2% range of Target Exchange Rate, while the combination of CryptoFed's interest rate and rewards (1b) and (1c) in FIG. 2 will only be adjusted every three months. During the three-month interval between the combined adjustments of CryptoFed's interest rate and rewards (1b) and (1c) in FIG. 2, through CryptoFed's Open Market Operation, if the net Ducat amount (Ducat sold minus Ducat purchased) is positive (or negative), there is deflationary (or inflationary) pressure in the system respectively. The net Ducat amount will be the first objective indicator for the quarterly adjustment of CryptoFed's interest rate and rewards (1b) and (1c) in FIG. 2. When the net Ducat amount (Ducat sold minus Ducat purchased) is positive, CryptoFed's interest rate for the next quarter will be lowered, and rewards to consumers (1b) and rewards to merchants (1c) in FIG. 2, will be increased. When the net Ducat amount (Ducat sold minus Ducat purchased) is negative, CryptoFed's interest rate for the next quarter will be increased, and rewards to consumers (1b) and rewards to merchants (1c) in FIG. 2, will be reduced. Following this first indicator, smart contracts on CryptoFed's blockchains can automatically execute the combined adjustments of CryptoFed's interest rate and rewards (1b) and (1c) in FIG. 2 on a quarterly basis.

The second indicator can be expressed in the net Locke amount (Locke purchased minus Locke sold) during the three-month interval. When the net Locke amount becomes negative, there will be inflationary pressure. When the amount of Locke sold exceeds a certain amount, such as twice the amount of Locke purchased, it will be obvious that the inflationary pressure cannot be cured by Ducat buyback with Locke. At this moment, the preventive predetermined emergency mode is triggered. The combined adjustments of CryptoFed's interest rate and rewards (1b) and (1c) in FIG. 2, which is twice as strong as the previous regular three-month adjustment, will be implemented immediately, while Ducat buyback with Locke will continue unless Locke price has already fallen below certain amount, such as $0.05 USD per token. The interest rate for Ducat holders will be increased substantially, while the rewards rate to consumers and merchants will be reduced substantially. During Ducat depreciation, merchants will continue receiving additional Ducat to cover exchange loss caused by conversion from Ducat to USD, while consumers will buy more Ducat to enjoy more discount at merchants. During the implementation of the preventive combined adjustments of CryptoFed's interest rate and rewards (1b) and (1c) in FIG. 2, whenever Ducat price falls below a certain threshold over a certain period time, such as 10% below its previous price over a 24-hour period, the same preventive combined adjustments will be repeated until the compounding effect cures the inflation. Once the Ducat price is back to the 2% deviation range of Target Exchange Rate, and if Locke price is above certain price per unit, such as $0.05 USD per token, then Locke can be used again to buy back Ducat as usual.

In the embodiment disclosed herein, the predetermined methods for Ducat money supply are primarily based on the consumptive activities (1b), (1c) and (1d) in FIG. 2 of mass consumers. These consumptive activities are coordinated and executed by the decentralized blockchains of CryptoFed. Through the decentralized blockchains of CryptoFed, merchants and consumers pursue their own self-interest without the needs of fiduciary duties among participants. In addition, the holders of Locke and Ducat, including merchants and consumers, are selling and buying these tokens through crypto markets and constantly provide market price signals of these tokens. In response to these market price signals from open crypto markets, CryptoFed automatically executes predetermined money supply mechanism which combines the adjustments of CryptoFed's interest rate and rewards (1b) and (1c) in FIG. 2, in conjunction with the Shield for Merchants' Exchange Loss. To this extent, in addition to CryptoFed's blockchains, the free market providing the price signals is another effective and efficient coordinator for CryptoFed's monetary system.

CryptoFed does not have lending and borrowing functions, but people will build lending and borrowing businesses in Ducat by themselves for their own interest. CryptoFed's interest rate will have a fundamental impact on the borrowing and lending market, because lenders will not lend their Ducat if they can earn interest payments automatically from CryptoFed. To this extent, CryptoFed's interest becomes the floor for the borrowing and lending market. Because CryptoFed only focuses on Ducat money supply (including Ducat money creation and Ducat money destruction for the adjustment of the total Ducat stock in the economy), the function of Ducat borrowing and lending is completely separated from Ducat money supply function. Even if a lot of Ducat borrowing and lending businesses go under, CryptoFed's money supply methods disclosed herein will still be functional, in response to mass consumers' purchases of consumption goods and services at merchants in Ducat. Conversely, under the current fractional banking system of the Fed, the function of borrowing and lending in USD is not separated from the banking system. Money supply of the Fed's fractional banking system (money creation and destruction) relies on the USD borrowing and lending market. Without lending by banks, there would be no additional money supply. When bank loans are repaid, the money supply decreases because the money created when the loan was issued is destroyed. Borrowers' default may potentially cause a total collapse of the entire monetary (banking) system through contagion, and therefore, the collapse of the USD money supply function. The USD banking system of the Fed is so fragile that it requires insurance from the Federal Deposit Insurance Corporation (FDIC), a federal regulatory agency.

The risk of debt default is an inherent and fundamental issue of the Fed's fractional banking system which has and will continue to generate financial crisis of the entire monetary system, from time to time. To the contrary, CryptoFed will eliminate the risk of debt default by completely separating Ducat money supply function from the function of Ducat borrowing and lending. From the perspective of coordinating human actions on a large scale, CryptoFed and the Fed represent two diametrically opposed operations: Decentralized vs. Centralized, Autonomous vs. Regulatory, Free Market vs. Governmental Control. In the future, no matter how many banks go under in the U.S during a given financial crisis, CryptoFed will have resilience and can function well as an alternative monetary system for individuals and entities, such as consumers and merchants, to meet their needs of daily transactions. Given that a banking crisis happens periodically, the role of CryptoFed will become more and more important in stabilizing the U.S. economy overtime as an alternative monetary system.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for an endogenous decentralized monetary system, comprising:
a) deploying, via one or more smart contracts on a blockchain network, a governance token and a currency token, wherein the governance token represents rights for rulemaking or decision-making process for the monetary system and has finite number,
wherein the currency token is configured for consumer transactions with participating retail merchants;
b) issuing, at least a portion of the governance tokens to merchants, individuals, or entities;
c) issuing the currency token upon satisfaction of issuance criteria comprising at least one of:
(i) a predetermined trading time of the governance token, or (ii) a market price threshold of the governance token;
d) executing, via the one or more smart contracts, consumer transactions in the currency token and, automatically and simultaneously delivering a reward percentage of each transaction for at least a consumer, a merchant, and a payment gateway; and
e) dynamically adjusting, via the one or more smart contracts, at least one of (i) the reward percentage or (ii) interest rate credited to holders of the currency token, based on one or more indicators of inflation or deflation, so as to stabilize the value of the currency token and maintain the decentralized monetary system without central authority intervention.

2. The method of claim 1, wherein the governance tokens is tradable on one or more cryptocurrency markets to form secondary markets for the governance token.

3. The method of claim 1, wherein the reward percentage to the payment gateway is delivered through merchants, and adjusted periodically by rules or decisions of the governance tokens to offset a transaction fee to achieve zero net transaction fees for participating merchants.

4. The method of claim 1, wherein the one or more indicators of inflation or deflation are measured by a percentage change of prices of a set of consumption goods and services in the currency token in a given time period.

5. The method of claim 1, wherein the one or more indicators of inflation or deflation comprise a net difference between currency tokens sold and currency tokens repurchased by the monetary system in a given time period.

6. The method of claim 1, wherein the one or more indicators of inflation or deflation comprise a net difference between governance tokens sold and governance tokens repurchased by the monetary system in a given time period.

7. The method of claim 1, wherein the interest rate credited to currency token holders is non-negative and adjustable, despite the absence of borrowing or lending relationship between the monetary system and the currency token holders.

8. The method of claim 1, wherein the blockchain network comprises one or more distributed ledgers configured to execute the smart contracts and record all transactions of the governance token and the currency token.

9. The method of claim 1, further comprising detecting a crisis condition when a ratio of governance tokens sold to governance tokens repurchased exceeds a predefined threshold, and triggering a stabilization policy in response.

10. The method of claim 1, further comprising calculating a target exchange rate of the currency token relative to a fiat currency based on a desired zero-inflation rate of the currency token and a published inflation index of the fiat currency.

11. The method of claim 10, wherein the one or more indicators of inflation or deflation of the currency token are measured by a percentage deviation from the target exchange rate.

12. The method of claim 10, further comprising compensating a retail merchant for an exchange loss determined from a difference between the target exchange rate and an actual exchange rate for conversion of the currency token into the fiat currency.

13. The method of claim 10, further comprising issuing new currency tokens for sale on the one or more cryptocurrency markets when an actual market price of the currency token exceeds the target exchange rate by more than a threshold percentage, and using proceeds from the sale exclusively to repurchase governance tokens from crypto markets for destruction.

14. The method of claim 10, further comprising issuing governance tokens to repurchase currency tokens from the one or more cryptocurrency markets when the actual market price of the currency token falls below the target exchange rate by more than a threshold percentage, and destroying the repurchased currency tokens.

15. The method of claim 1, wherein the smart contracts automatically adjust consumer reward percentages, merchant reward percentages, and the interest rate according to a predetermined policy cycle until inflation or deflation is stabilized at a range of an upper bound 2% and lower bound 2% from the target exchange rate.

16. The method of claim 1, wherein the governance tokens are distributed, free of charge, to ensure participation in governmental affairs of the monetary system, such as rulemaking.

17. A method for an endogenous decentralized monetary system, comprising:
i. providing a governance token, the holders of which have the right to participate in rulemaking or decision-making process for the monetary system; and
ii. providing a currency token, which can be used by holders to purchase goods and services at participating retail merchants; and
iii. the governance token, which must have a finite number; and
iv. the currency token, which does not have a finite number; and
V. the governance token, which is distributed, free of charge, to these retail merchants, individuals and entities who may participate in governmental affairs of the monetary system and may sell certain amount of governance token on crypto markets to form secondary markets for the governance token; and
vi. the currency token, which will not be issued until the governance token has been traded on crypto markets for a certain time and reaches a certain price per unit; and
vii. the currency token, whenever it is used by a consumer to purchase consumption goods and services at a retail merchant, various percentages of the currency token are paid by the monetary system, as rewards, to the consumer, merchant and crypto payment gateways (including all payment processors) through the merchant; and
viii. the reward paid to crypto payment gateways through the merchant, which is to cover transaction fees charged whatsoever to the merchant by crypto payment gateways to achieve zero transaction fees for merchants; and
ix. the rewards to the consumer, the merchant and the crypto payment gateways through the merchant, which the monetary system can adjust for achieving zero inflation and deflation measured by the percentage change of prices of a set of consumption goods and services in the currency token in a given time period; and
x. the currency token holders, who receive an interest payment from the monetary system at an interest rate determined by the monetary system from time to time, although there is no borrowing and lending relationship between the monetary system and the currency token holders; and
xi. the interest rate, which can go as high or low as needed, but it will never be negative; and
xii. the interest rate, which the monetary system can adjust for achieving zero inflation and deflation; and
xiii. a target exchange rate between the currency token and the US dollar, which can be obtained through calculation under the ceteris paribus condition, because the currency token has a desired annual zero inflation/deflation rate and the US dollar has an actual annual core PCE inflation rate published monthly by the U.S. Bureau of Economic Analysis; and
xiv. the currency token's actual inflation and deflation, which can be measured by deviation from the target exchange rate, because the ceteris paribus condition can never be met; and
xv. a retail merchant, which receives the currency token from the monetary system to cover exchange loss caused by conversion from the token currency to the US dollar; and
xvi. the merchant's exchange loss, which is measured by the difference between the target exchange rate and the actual exchange rate of the merchant's conversation from the currency token to the US dollar; and
xvii. the currency token, which is newly created and sold by the monetary system on crypto markets in exchange for the US dollar stablecoins, when the currency token's price against US dollar is higher than the target exchange rate, and surpasses certain percentage of the target exchange rate at a given time period; and
xviii. the proceeds of US dollar-pegged stablecoins received by the monetary system, which can only be used to buy back the governance token from crypto markets; and
xix. the governance token bought back from crypto markets by the monetary system, which must be burnt (destroyed); and
xx. the governance token, which the monetary system can issue to buy back the currency token, when the currency token's price against US dollar is lower than the target exchange rate, and surpasses certain percentage of the target exchange rate; and
xxi. the currency token bought back by the monetary system, which must be burnt (destroyed); and
xxii. a first indicator of inflation and deflation, which is the difference between the currency token sold minus the currency token bought at a given time period; and
xxiii. a direction to increase CryptoFed's interest rate and reduce the rewards to consumers and merchants, when the first indicator is negative; and
xxiv. a direction to reduce CryptoFed's interest rate and increase the rewards to consumers and merchants, when the first indicator is positive; and
XXV. a second indicator of inflation and deflation, which is the difference between the governance token sold minus the governance token bought at a given time period; and
xxvi. a direction to increase CryptoFed's interest rate and reduce the rewards to consumers and merchants, when the second indicator is positive; and
xxvii. a direction to reduce CryptoFed's interest rate and increase the rewards to consumers and merchants, when the second indicator is negative; and
xxviii. an indicator of crisis of the currency token, which the governance token sold divided by the governance token bought exceeds two (2) in a given time period.

18. The method of claim 17, wherein the monetary system is on blockchain.

19. The method of claim 17, wherein the monetary system distributes the right to retail merchants, individuals or entities to acquire the governance tokens at their discretion.

20. The method of claim 17, wherein there is a sign-up bonus for these consumers who are the first-time users of the currency token.

21. The method of claim 17, wherein the given time period is three (3) months.

22. The method of claim 17, wherein the interest rate is a standard interest rate which is 1% higher than the Fed's real federal funds rate defined as the Fed's effective federal funds rate minus the annual core PCE inflation rate published by the U.S. Bureau of Economic Analysis.

23. The method of claim 22, wherein a typical life cycle of combined adjustments for curing inflation and/or deflation consists of the following steps, following the first indicator for the quarterly adjustment of CryptoFed's interest rate and rewards:
Step 1: A combination of 20% consumer reward reduction towards 5.5%, 15% merchant reward reduction towards 1% and 0.25% increase of interest rate from the Standard Ducat Interest Rate, can be implemented and repeated every quarter until the inflation is cured. The Standard Ducat Interest Rate is 1% higher than the Fed's real federal funds rate.
Step 2: Once the inflation is cured, the next quarterly adjustment is to reduce the interest rate 0.25% each quarter towards the Standard Ducat Interest Rate, while continuing the reduction of 20% on consumer reward rate and 15% on merchant reward rate to preempt inflation revival due to CryptoFed's interest rate reduction.
Step 3: When, and only when, CryptoFed's interest rate reaches the Standard Ducat Interest Rate, will the reductions of interest rate, consumer reward and merchant reward stop.
Step 4: If inflation restarts under the Standard Ducat Interest Rate, the reduction of 20% on consumer reward rate and 15% on merchant reward rate will be resumed until the rewards reach 5.5% to consumers and 1% to merchants.
Step 5: If inflation continues when consumer reward is 5.5% and merchant reward is 1%, the interest rate will be raised again by 0.25% each quarter until the inflation is cured or the interest rate reaches 5%, whichever is earlier.
Step 6: When, for four consecutive quarters, Ducat inflation cannot be cured by the combination of 5.5% reward rate to consumers and 1% to merchants, and 5% interest rate, then, the reward rate to consumers (5.5%) and to merchants (1%) will be lowered 20% quarterly towards the direction of zero, until the inflation is cured.
Step 7: Once the inflation is cured, the highest priority is to reduce interest rate 0.25% each quarter and move CryptoFed's interest rate towards the level of the Standard Ducat Interest Rate, but the interest rate previously reduced will be reversed if inflation restarts.
Step 8: If the Standard Ducat Interest Rate is reached and maintained, the reward rate to consumers will be raised 20% each quarter towards 5.5% or higher and the reward to merchants 15% each quarter towards 1% or higher respectively, but the rewards previously raised will be reversed if inflation restarts.
Step 9: Under the condition that CryptoFed's interest rate is on the level of the Standard Ducat Interest Rate, the reward rate to consumers is 5.5% or higher, and the reward to merchants is 1% or higher respectively, if there is neither inflation nor deflation, the status quo will be maintained.
Step 10: If there is deflation, the increase of 20% of the consumer reward rate and 15% of the merchant reward rate respectively, will be repeated every quarter until the deflation is cured, while the Standard Ducat Interest Rate is maintained.
Step 11: The life cycle of Step 1 through Step 10 can be repeated as needed.

24. The method of claim 23, wherein the combination of the reward rates and interest rate can be further adjusted.
